(19) United States
(12) Patent Application Publication
(10) Pub. No.: US 2012/0047526 A1
(43) Pub. Date: Feb. 23, 2012

(54) System and Method for Mapping Audio and Video Streams from Audio/Video Source to Multiple Audio/Video Sinks

(75) Inventors: Syed A. Hussain, Toronto (CA); Collis Q. Carter, Richmond Hill (CA); Gabriel L. Abarca, Richmond Hill (CA)

(73) Assignee: ATI Technologies ULC, Markham (CA)

(21) Appl. No.: 12/860,549

(22) Filed: Aug. 20, 2010

(51) Int. Cl. H04N 7/16

(52) U.S. Cl. 725/25

(57) ABSTRACT

System and method for mapping audio and video streams from an audio/video (AV) source to respective ones of a plurality of AV sinks. In accordance with one or more embodiments, the audio and video playback and content protection capabilities of each one of the AV sinks are determined based on AV data received via a video channel interface from each one of the AV sinks. Also determined are the audio and video streams available from the AV source. Respective ones of the audio and video streams available from the AV source are mapped to each one of the AV sinks in accordance with their audio and video playback and content protection capabilities.

### FIELD OF THE DISCLOSURE

The present disclosure relates to audio/video (AV) sources having multiple audio and video streams available for driving multiple AV sinks having multiple audio and video playback capabilities and content protection capabilities.

### BACKGROUND OF THE DISCLOSURE

In recent years, AV receivers, such as high definition televisions (HDTVs) and other AV receivers designed to process audio and video signals for driving separate video displays and sound systems, also known as AV sinks, have multiple audio playback capabilities, in addition to multiple video playback capabilities (e.g., multiple aspect ratios or resolutions). Additionally, improved digital display link technologies, such as high definition multimedia interface (HDMI) and DisplayPort with multiple audio and video streaming capabilities, enable AV sources, such as personal computers (PCs), to connect to multiple AV sinks using complex interfaces and connection topologies, including networks of repeaters or branch devices that can be configured by the AV source, rather than only fixed source-to-sink connections, and can include encryption for content protection. Accordingly, proper audio plug-and-play capability is increasingly important for a good user experience. This includes proper audio format and content protection negotiation, to ensure that the application plays a format supported by the intended AV sink, the content is properly protected, and there is proper routing of the audio stream to the proper AV sink, i.e., proper audio-video association.

However, due to the configuration of the link topology, accessing the sink capabilities, enabling of the sinks and enabling content protection must be done through the display device and link topology manager, as opposed to the audio device the end points of which are of fixed hardware. The problem with this approach is that the audio and video software stacks are separate. However, in order to have proper audio plug-and-play performance, the audio software stack requires access to the audio format and content protection capabilities of the sink (for format and content protection negotiation) and knowledge of which audio endpoint is connected to the desired sink (for proper audio-video associate), and these are actually under the display device, not the audio device.

Referring to FIG. 1, for example, a conventional AV source, such as a PC 1, includes one or more processors, such as a central processor unit (CPU) 10 and perhaps one or more graphics processor units (GPU), and interface devices, often referred to as “Northbridge” 12 and “Southbridge” 14, which provide video 12v and audio 14a interfaces and sources, respectively, for multiple AV sinks 16a, . . . , 16n. These interfaces 12v, 14a communicate with the sinks 16a, . . . , 16n via video 17va, . . . , 17vn and audio 17aa, . . . , 17an signals (which, as will be readily understood by one of ordinary skill in the art, can be wired or wireless signal channels). Each of the AV sinks 16a, . . . , 16n can have multiple audio and video capabilities. For example, the first AV sink 16a can have multiple audio capabilities 16aa1, 16aa2, . . . , and multiple video playback capabilities 16av1, 16av2, . . . .

Referring to FIG. 2, as is well known, the PC 1 uses an operating system 20 to control its functions. These functions are provided with commands and/or inputs 23 received from one or more applications and/or a user 22. The video 12v and audio 14a interfaces (FIG. 1) include video 24v and audio 24a interface and source programs which communicate 21v, 21a with the operating system and provide the video 17va, . . . , 17vn and audio 17aa, . . . , 17an streams for the AV sinks 16a, . . . , 16n. As will be readily appreciated, these programs 24v, 24a can be hardwired in as respective parts of the video 12v and audio 14a interfaces, or can be loaded from remote memory locations elsewhere within or under the control of the PC 1.

As discussed above, it is such use of separate video 24v and audio 24a interfaces that often create audio/video association problems between the video 21v and audio 21a information originated by the operating system 20 to control the audio and video streams provided to the AV sinks 16a, . . . , 16n.

This current lack of coordination between the audio and video streams becomes particularly problematic when various requests come from the application or user 22. For example, managing, configuring, querying and enabling the AV sinks 16a, . . . , 16n becomes problematic due to significant interdependencies among the audio-only, video-only and audio/video sinks 16a, . . . , 16n that need proper management for a good user experience. For example, the hardware may have limited numbers of audio and video encoders, and the video and audio sinks share the links and branch devices and are, therefore, constrained to the bandwidth of such topology. In DisplayPort, a sink can be audio-only, while in HDMI the sink must have a video mode active in order to be able to receive and play back audio. Further, particularly in HDMI but also in DisplayPort, the active video mode affects the supported audio formats.

Additionally, a power down request might be issued for audio content only, video content only, or both, and requires proper coordination. The same goes for a content protection request. Additionally, saving and restoring a user configuration of the system for both the audio and video portions would be desirable.

Conventional systems and methods rely on the audio device endpoint hardwired to a physical connector. The display device driver automatically writes the relevant sink capabilities and a sink identification within registers in the fixed audio device endpoint. These registers are later accessed by the audio device for purposes of format and content protection negotiation and audio-video association. However, such systems and methods manage the configuration and enabling of the sinks only from the video side, leaving the audio enabled only after the video is enabled, with no capability for enabling audio-only sinks. For example, there is no mechanism to enable links of the topology or video mode in an HDMI sink for audio-only playback. Accordingly, this prevents audio-only playback, e.g., listening to music on an HDTV with a blanked video display.

For every video mode change, the display device driver must update the audio capabilities in the hardware registers of the audio device endpoint. There is no mechanism for negotiating a joint audio-video format that matches the sink capability with the user requirements, or to change the video mode in order to support the desired audio format, since the audio negotiation is done only after the video. This limits the ability to do audio playback in specific formats desired by the user.

Further, conventional systems and methods control the power and content protection of encoders, links and sinks from the video side only. They do not include mechanisms to do audio-only, video-only or audio plus video power down or content protection which would only power down or enable for content protection the encoders, links and sinks used only for audio, only for video, or both, respectively. This limits power savings and resource optimization capabilities of the system.

Additionally, current systems and methods do not provide automatic system configuration save and restore capabilities for audio as well as video.

As a result, conventional systems and methods do not support all possible topologies and multiple sinks. To do so would require as many audio device endpoints as potential sinks to be connected in the topology, which can be virtually unlimited. However, only a few audio device endpoints are generally included due to the cost of additional registers and audio encoding hardware.

Further, such systems and methods do not support cloning of a stream, i.e., under control by the source through sideband communication, a branch device can send a replicated or cloned incoming stream from the source as multiple outgoing streams to the sink. In this case, an audio device endpoint would be associated to more than one sink, and this is not supported by existing systems which rely on a single sink identification and capability register set for each audio endpoint.

Additionally, without input from the application 22, the display device driver is unable to correctly map sinks to audio device endpoints. Mapping of a sink with an audio endpoint not having the same capabilities can occur, thereby precluding the playback of the content in the format intended by the application.

Further, absent a standard form of mapping, any mapping policy used by the display device vendor can lead to mapping unsupported by the application 22, particularly if audio endpoints are hardwired to physical connectors. For example, if a topology allows a sink to be accessed through two different physical connectors, the display device driver may decide to map the sink to both audio endpoints and the application 22 may be confused by the use of the same sink capabilities listed two times.

Further, conventional systems are not future proof. As digital display link technologies and audio capabilities evolve, more hardware changes will be required in the audio endpoint registers, causing audio plug-and-play support to lag behind digital display capabilities.

Further, the ability to do audio-only playback or audio playback in the format desired by the application or user 22 is limited by the inability of the sink manager to let sinks be enabled at the request of the audio side only, and the fact that audio can use only formats determined by the link and video mode settings and cannot request changes.

Further, encoders, links and sinks cannot be powered down as often as the audio portion. Additionally, audio system configuration and user preferences are not jointly restored with the video configuration.

### BRIEF DESCRIPTION OF THE DRAWINGS

FIG. 1 is a functional block diagram of a conventional audio/video (AV) source driving multiple AV sinks.

FIG. 2 is a functional block diagram depicting a conventional system for controlling audio and video streams from an AV source to multiple AV sinks.

FIG. 3 is a functional block diagram of a system in accordance of an exemplary embodiment for mapping audio and video streams from an AV source to respective ones of multiple AV sinks.

FIG. 4 is a functional block diagram of one exemplary embodiment of a hardware implementation of the AV control of FIG. 3.

FIG. 5 is a flowchart depicting mapping of audio and video streams from an AV source to respective ones of multiple AV sinks in accordance with an exemplary embodiment.

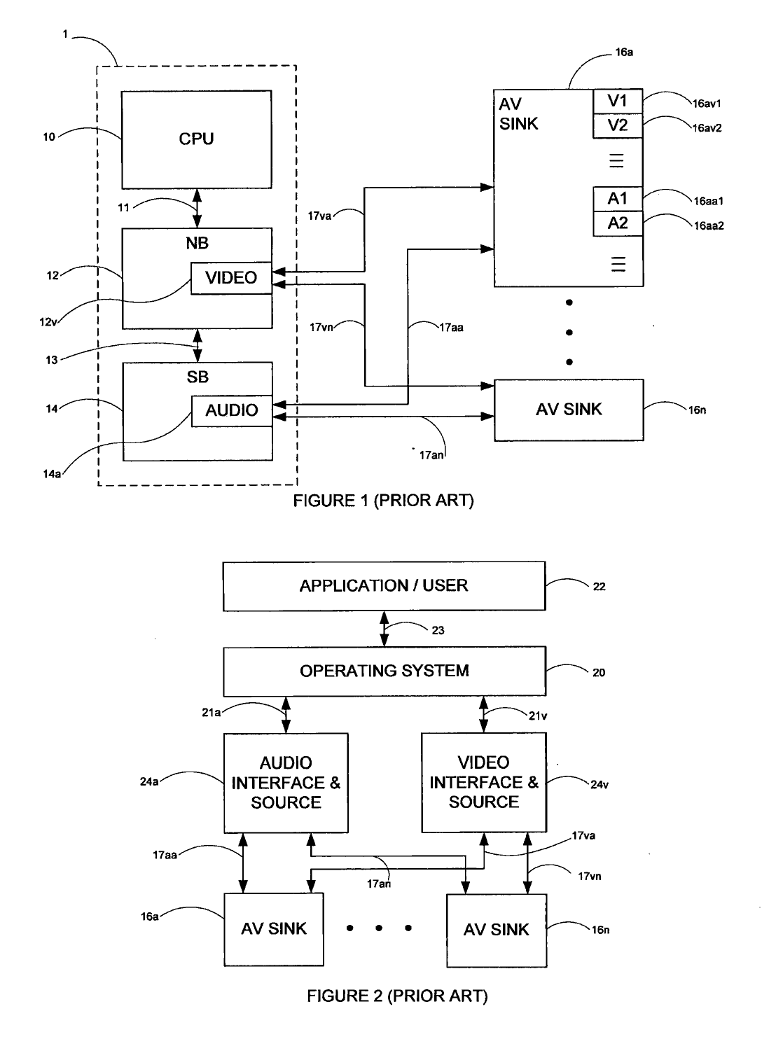

### DETAILED DESCRIPTION OF THE PREFERRED EMBODIMENTS

A system and method for mapping audio and video streams from an AV source to respective ones of multiple AV sinks are provided. In accordance with one or more embodiments, the audio and video playback and content protection capabilities of each one of the AV sinks are determined based on AV data received via a video channel interface from each one of the AV sinks. Also determined are the audio and video streams available from the AV source. Respective ones of the audio and video streams available from the AV source are mapped to each one of the AV sinks in accordance with their audio and video playback capabilities.

Advantageously, such system and method provide for managing, configuring, querying and enabling the sinks, allowing them to be done jointly for audio and video, and initiated by either the audio or video. Accordingly, the audio is capable of enabling links in the topology and a video mode in an HDMI sink for audio-only playback, as well as change the video mode to support a desired audio format.

Further advantageously, such system and method support audio-only, video-only and audio plus video power down and content protection enabling by providing for powering down or enabling for content protection only the respective encoders, links and sinks used only for audio, only for video or for both, respectively, thereby optimizing power savings and resource allocation. Additionally, the sink manager can automatically restore all audio and video encoders, links and sinks based on the prior user configuration and profile.

Further advantageously, such system and method allows an audio only sink to be enabled based on audio only content, independent power management of audio and video sources, and the control layer (e.g., in an operating system or application) to select the AV source best optimized for content (e.g., HBR audio or HD video content). Additionally, such system and method allows the sink audio capability to be exposed through a video device instead of an audio device, while audio source capability is still exposed via the audio device, thereby providing for easy extension of sink capability exposure. Also, such system and method allows for proper management of the AV source as control layer (in OS and application) has complete view of the video sources and audio source and the interdependency between them.

As a result, problems associated with conventional systems are solved. Virtually all possible topologies and multiple sinks are supported since they are all visible to the video device. Stream cloning is supported because audio-video association is not determined by a single sink identification register within the audio endpoint, but is decided by the application which has complete visibility of both the audio device and video device. The application is able to request the display device driver/link topology manager that an audio endpoint it wants to use be associated with two or more sinks as determined by the application. With visibility into both the audio endpoint and sink capabilities, the application can correctly map a sink with an audio endpoint that has the same capabilities, thereby enabling playback of content in the desired format and with the desired content protection. The audio-video association is not ambiguous or unpredictable, but is robustly handled by the display device driver always responding to explicit application requests. Such a system is future proof, since as digital display link technologies and audio capabilities evolve, updates in audio capabilities can be done via software in the display device driver, with no more hardware changes required within the audio endpoint registers. Audio-only playback or audio playback in the format and content protection desired by the user is not limited by the video, since the sink manager allows encoders, links, sinks to be enabled and video modes to be changed at the request of the audio side. Encoders, links and sinks can be powered down as desired when the audio is powered down, irrespective of video playback. User preferences for audio configuration can be automatically restored in line with the video configuration.

The following detailed description is of example embodiments of the presently claimed invention with references to the accompanying drawings. Such description is intended to be illustrative and not limiting with respect to the scope of the present invention. Such embodiments are described in sufficient detail to enable one of ordinary skill in the art to practice the subject invention, and it will be understood that other embodiments may be practiced with some variations without departing from the spirit or scope of the subject invention.

Throughout the present disclosure, absent a clear indication to the contrary from the context, it will be understood that individual circuit elements as described may be singular or plural in number. For example, the terms “circuit” and “circuitry” may include either a single component or a plurality of components, which are either active and/or passive and are connected or otherwise coupled together (e.g., as one or more integrated circuit chips) to provide the described function. Additionally, the term “signal” may refer to one or more currents, one or more voltages, or a data signal. Within the drawings, like or related elements will have like or related alpha, numeric or alphanumeric designators. Further, while the present invention has been discussed in the context of implementations using discrete electronic circuitry (preferably in the form of one or more integrated circuit chips), the functions of any part of such circuitry may alternatively be implemented using one or more appropriately programmed processors, depending upon the signal frequencies or data rates to be processed. Moreover, to the extent that the figures illustrate diagrams of the functional blocks of various embodiments, the functional blocks are not necessarily indicative of the division between hardware circuitry. Thus, for example, one or more of the functional blocks (e.g., processors, memories, etc.) may be implemented in a single piece of hardware (e.g., a general purpose signal processor, random access memory, hard disk drive, etc.). Similarly, any programs described may be standalone programs, may be incorporated as subroutines in an operating system, may be functions in an installed software package, etc.

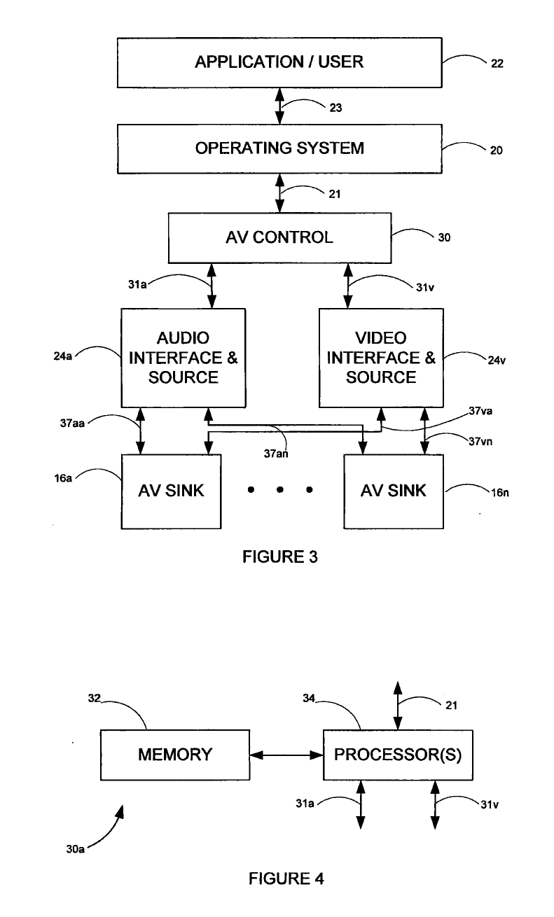

Referring to FIG. 3, in accordance with a preferred embodiment, AV control 30 can be interposed between the operating system 20 and the audio device (audio interface and source) 24a and video device (video interface and source) 24v, substantially as shown. As discussed above, the AV control 30 is in communication 21 with the operating system 20, which, in turn, is in communication 23 with the application and user 22. In accordance with commands and inputs from the application and user 22, and the resulting commands issued by the operating system 20, the AV control 30 determines the audio and video playback capabilities of the AV sinks 16a, . . . , 16n via the video channel interface formed by the video device 24v and communication channels 31v, 37va, . . . , 37vn. The AV control 30 also determines the audio and video streams available via the audio 24a and video 24v devices. Then, in accordance with the needs or desires of the application or user 22, the AV control 30 maps respective ones of the available audio and video streams from the AV sources 24a, 24v to each one of the AV sinks 16a, . . . , 16n.

Also via such video channel interface, the AV control 30 can provide one or more commands for querying each of the AV sinks 16a, . . . , 16n about its respective audio and video playback capabilities. Further, the AV control 30 can provide one or more commands via the video channel interface 24v to disable one or more of the audio and video playback capabilities of one or more of the AV sinks 16a, . . . , 16n. Additionally, the AV control 30 can provide one or more commands for enabling and disabling mapping of selected ones of the available audio and video streams to the AV sinks 16a, . . . , 16n.

The mapping of the available audio and video streams can be done in accordance with a number of techniques, including a hierarchy of the available audio and video streams (e.g., beginning with the highest video resolution possible from the source and successively downgrading the resolution to match the highest resolution of which a particular AV sink is capable of displaying), and those audio and video streams defined by the application or user 22.

As discussed above, preferred embodiments support a display system and method allowing direct responses to sink audio format supported queries from the application. Also provided is the capability to map any audio device endpoint in the host system, e.g., a GPU, with any connected sink in the topology as requested by the application. Audio device endpoints are not hardwired to a physical connector. The display device driver does not need to write any sink capabilities within registers in a fixed audio device endpoint. Instead, audio format negotiations are handled directly by the display device driver.

Referring to FIG. 4, in accordance with an exemplary embodiment, the AV control 30 can be implemented as executing software stored in a memory 32 operably coupled to one or more processors 34. These one or more processors 34, in accordance with the executable instructions stored in the memory 32, perform the operations as described herein.

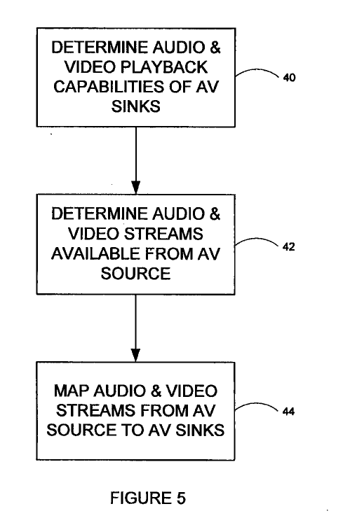

Referring to FIG. 5, a method in accordance with another embodiment includes a step 40 of determining audio and video playback capabilities of each of the AV sinks 16a, . . . , 16n based on AV data received from each of the AV sinks 16a, . . . , 16n via the video channel interface 24v. Also included is a step 42 of determining the audio and video streams available from the AV source. Further included is a step 44 of mapping the audio and video streams available from the AV source to each of the AV sinks 16a, . . . , 16n in accordance with their audio and video playback capabilities.

As discussed above, the determination of the audio and video playback capabilities of the AV sinks 16a, . . . , 16n can include providing one or more commands for querying each of the AV sinks 16a, . . . , 16n via the video channel interface 24v about the AV data. Further as discussed above, the mapping of the available audio and video streams can be done in accordance with a hierarchy of the available audio video streams, or audio and video streams as defined by the application or user 22. Additional steps can include providing one or more commands for one or more of the AV sinks to disable one or more of the audio and video playback capabilities, and providing one or more commands for enabling and disabling mapping of selected ones of the audio and video streams from the AV source to each of the AV sinks.

Various other modifications and alternations in the structure and method of operation of this invention will be apparent to those skilled in the art without departing from the scope and the spirit of the invention. Although the invention has been described in connection with specific preferred embodiments, it should be understood that the invention as claimed should not be unduly limited to such specific embodiments. It is intended that the following claims define the scope of the present invention and that structures and methods within the scope of these claims and their equivalents be covered thereby.

What is claimed is:

1. A method of mapping audio and video streams from an audio/video (AV) source to respective ones of a plurality of AV sinks, comprising:
determining audio and video playback and content protection capabilities of each one of said plurality of AV sinks based on AV data received via a video channel interface from each one of said plurality of AV sinks;
determining a plurality of audio and video streams available from said AV source; and
mapping respective ones of said plurality of audio and video streams available from said AV source to each one of said plurality of AV sinks in accordance with said audio and video playback and content protection capabilities.

2. The method of claim 1, wherein said determining audio and video playback and content protection capabilities of each one of said plurality of AV sinks comprises providing one or more commands for querying each one of said plurality of AV sinks via said video channel interface about said AV data.

3. The method of claim 1, wherein said mapping respective ones of said plurality of audio and video streams available from said AV source to each one of said plurality of AV sinks comprises mapping said respective ones of said plurality of audio and video streams in further accordance with at least one of:
a hierarchy of said plurality of audio and video streams available from said AV source; and
a user-defined one or more of said plurality of audio and video streams available from said AV source.

4. The method of claim 1, further comprising providing one or more commands for one or more of said plurality of AV sinks to disable one or more of said audio and video playback capabilities thereof.

5. The method of claim 1, further comprising providing one or more commands for enabling and disabling mapping of selected ones of said plurality of audio and video streams from said AV source to each one of said plurality of AV sinks.

6. An apparatus including circuitry, comprising:
audio/video (AV) control circuitry for mapping audio and video streams from an AV source to respective ones of a plurality of AV sinks by:
determining audio and video playback and content protection capabilities of each one of said plurality of AV sinks based on AV data received via a video channel interface from each one of said plurality of AV sinks;
determining a plurality of audio and video streams available from said AV source; and
mapping respective ones of said plurality of audio and video streams available from said AV source to each one of said plurality of AV sinks in accordance with said audio and video playback and content protection capabilities.

7. The apparatus of claim 6, wherein said determining audio and video playback and content protection capabilities of each one of said plurality of AV sinks comprises providing one or more commands for querying each one of said plurality of AV sinks via said video channel interface about said AV data.

8. The apparatus of claim 6, wherein said mapping respective ones of said plurality of audio and video streams available from said AV source to each one of said plurality of AV sinks comprises mapping said respective ones of said plurality of audio and video streams in further accordance with at least one of:
a hierarchy of said plurality of audio and video streams available from said AV source; and
a user-defined one or more of said plurality of audio and video streams available from said AV source.

9. The apparatus of claim 6, further comprising providing one or more commands for one or more of said plurality of AV sinks to disable one or more of said audio and video and content protection playback capabilities thereof.

10. The apparatus of claim 6, further comprising providing one or more commands for enabling and disabling mapping of selected ones of said plurality of audio and video streams from said AV source to each one of said plurality of AV sinks.

11. An apparatus, comprising:
memory capable of storing executable instructions for mapping audio and video streams from an audio/video (AV) source to respective ones of a plurality of AV sinks; and
at least a first processor operably coupled to said memory and responsive to said executable instructions by
determining audio and video playback and content protection capabilities of each one of said plurality of AV sinks based on AV data received via a video channel interface from each one of said plurality of AV sinks,
determining a plurality of audio and video streams available from said AV source, and
mapping respective ones of said plurality of audio and video streams available from said AV source to each one of said plurality of AV sinks in accordance with said audio and video playback capabilities.

12. The apparatus of claim 11, wherein said determining audio and video playback and content protection capabilities of each one of said plurality of AV sinks comprises providing one or more commands for querying each one of said plurality of AV sinks via said video channel interface about said AV data.

13. The apparatus of claim 11, wherein said mapping respective ones of said plurality of audio and video streams available from said AV source to each one of said plurality of AV sinks comprises mapping said respective ones of said plurality of audio and video streams in further accordance with at least one of:
a hierarchy of said plurality of audio and video streams available from said AV source; and
a user-defined one or more of said plurality of audio and video streams available from said AV source.

14. The apparatus of claim 11, further comprising providing one or more commands for one or more of said plurality of AV sinks to disable one or more of said audio and video playback and content protection capabilities thereof.

15. The apparatus of claim 11, further comprising providing one or more commands for enabling and disabling mapping of selected ones of said plurality of audio and video streams from said AV source to each one of said plurality of AV sinks.
